(19) United States
(12) Patent Application Publication
(10) Pub. No.: US 2003/0028556 A1
(43) Pub. Date: Feb. 6, 2003

(54) Method for analyzing events from system firmware and software

(76) Inventors: Michael S. Allison, Fort Collins, CO (US); Stephen Silva, Fort Collins, CO (US); Stephen Patrick Hack, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 09/918,425

(22) Filed: Jul. 28, 2001

(51) Int. Cl. G06F 17/24

(52) U.S. Cl. 707/500; 707/531

(57) ABSTRACT

The invention provides methodology and processes that extract, separate, filter, and/or transform internally generated events deriving from electronic architectures such as server systems. The internally generated events may for example include chassis logs associated with one or more entities within the electronic architecture. The methodology also preferably transforms chassis logs (typically in binary format) to a text string. The text strings define one or more problems of the electronic architecture. The text strings are input to a series of analyzers corresponding to the series of entities within the architecture. The text strings define a problem detail file and a sequence of chassis codes linked to issues (e.g., problems or system health) within the architecture. The invention thus includes methodology to analyze the text strings, and to generate language statements representative of one or more chassis codes. By way of example, the language statements may be in the form of English statements providing an explanation of the problems experienced by the electronic architecture and/or by the individual entities.

### RELATED APPLICATION

This application is related to copending and cofiled application for U.S. letters patent Ser. No.______ , filed______ and entitled METHOD FOR EXTRACTING, FILTERING AND SEPARATING EVENTS FROM SYSTEM FIRMWARE AND SOFTWARE (Attorney Docket No. 10018215-1).

### BACKGROUND OF THE INVENTION

Complicated electronic systems such as server architectures typically include operating system software and processors, programmable devices, firmware files, I/O drivers, electronic sensors and monitors (collectively the “entities”). Managing these entities is a difficult task, particularly during development of the underlying architecture. Typically, during integration of the architecture, each of the entities is separately analyzed by technicians or engineers to determine appropriate operation and overall system health. At the system level, a failure or problem generated by any of the entities must be traced to the source, a time consuming process.

FIG. 1 shows a prior art system architecture 10 that may function as a UNIX server with multiple processing cells 12A-12D. Architecture 10 may generate events—often in the form of “chassis logs”—from internal entities to specify system health during boot-up and operation; such entities may for example include internal local processors 14A-14D, additional processors 16, 18, 20, 22 and I/O drivers 24A-D. Chassis logs generally consist of a series of one or more small messages (denoted as “chassis codes”). As architecture 10 boots, chassis logs are generated from cells 12 to a service processor 30. These chassis logs may be accessed from service processor 30 via a communication link, such as RS232 and LAN connection 32, 34, respectively.

Collectively, the events (e.g., chassis logs) generated by entities of architecture 10 are not easily assessed. Accordingly, engineers intimate with the design of architecture 10 are generally the ones responsible for debug operations involving the overall health of architecture 10. Specifically, if needed these engineers may decode the chassis logs

and codes from all entities to isolate a problem; however, this requires a series of tedious and time-consuming steps, such as:

Operating the architecture until a problem is detected

Evaluating the problem

Checking power resets and clocks

Obtaining chassis logs

Manually reviewing chassis logs and comparing the logs to key sequences

Synthesizing the problems and possible solutions

There is therefore the need to reduce and/or eliminate these steps in order to streamline debugging and/or evaluating of events (e.g., chassis logs) from system firmware and software. It is, accordingly, one object of the invention is to provide methods for extracting events, separating events from entities, filtering events, and transforming events to other formats. Another object of the invention is to provide a method for processing transformed events into a widely understood communication protocol. Other objects of the invention are apparent within the description that follows.

### SUMMARY OF THE INVENTION

In one aspect, the invention provides methodology and processes that extract, separate, filter, and/or transform internally generated events deriving from electronic architectures such as server systems. The internally generated events may for example include chassis logs associated with one or more entities within the electronic architecture. The methodology of this aspect is sometimes denoted with “getcc” herein. In one particular aspect, getcc forms a series of subroutines suitable to extract, separate, filter, and/or transform chassis logs and chassis codes. Preferably, getcc separates chassis logs according to the entity generating the event. Getcc also preferably transforms chassis logs (typically in binary format) to a text string.

These text strings, according to one aspect, define one or more problems of the electronic architecture. The text strings are preferably analyzed according to other aspects of the invention. By way of example, the text strings are input to a series of analyzers corresponding to the series of entities within the architecture. In one aspect, the text strings define a problem detail file and a sequence of chassis codes linked to issues (e.g., problems or system health) within the architecture.

In still another aspect, the invention includes an extraction tool system that connects with electronic architecture to extract and analyze internally generated events. By way of one example, the extraction tool system includes process modules to process the getcc functions so as to extract, separate, filter, and transform chassis logs. The extraction tool system of one aspect couples to the electronic architecture and thereafter extracts chassis logs, separates the chassis logs by entity, filters the chassis logs, and converts a binary version of the chassis log to text string.

In yet another aspect, the invention provides for methodology to analyze the text strings generated by getcc, and to generate language statements representative of one or more chassis codes. By way of example, the language statements may be in the form of English statements providing an explanation of the problems experienced by the electronic architecture and/or by the individual entities.

The invention of another aspect provides an analyzing system. The analyzing system couples with the extraction tool system to analyze text strings and to generate statements (e.g., English language statements) indicating problems or system health issues relating to the electronic architecture. In one aspect, the analyzing system sifts through chassis codes and locates errors; it also may produce an English explanation of, and a context for, those errors.

The invention provides useful advantages. An engineer familiar with electronic architecture may decode the bit streams representing chassis codes, and associated with internal entities, to debug problems. However, with the invention a technician unfamiliar with the electronic architecture may receive English statements of the problems so as to evaluate system health and to perform appropriate debug operations. The invention thus has particular use in checking revisions of software and firmware installed to the electronic architecture.

The invention is next described further in connection with preferred embodiments, and it will become apparent that various additions, subtractions, and modifications can be made by those skilled in the art without departing from the scope of the invention.

### BRIEF DESCRIPTION OF THE DRAWINGS

A more complete understanding of the invention may be obtained by reference to the drawings, in which:

FIG. 1 shows prior art electronic architecture that generates events relating to internal entities;

FIG. 2 is a block diagram of an extraction tool and analyzing system constructed according to the invention;

FIG. 3A and 3B illustrate an operational flow chart for getcc, in accord with the invention; and

FIG. 4A and 4B illustrate an operational flow chart for an analyzer shown in FIG. 2, in accord with the invention.

### DETAILED DESCRIPTION OF THE EMBODIMENTS

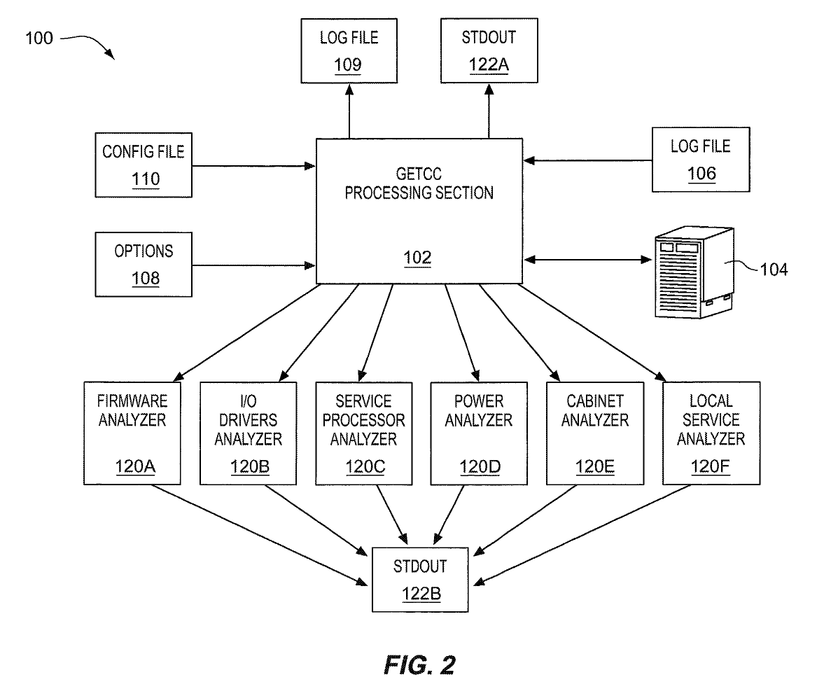

FIG. 2 shows an extraction tool and analyzing system 100 constructed according to the invention. At the core of system 100 is the getcc processing section 102. System 100 begins operation by obtaining internally generated events from a connected electronic architecture 104. By way of example, the internally generated events take the form of chassis logs produced by one or more entities within architecture 104. In an alternative configuration, system 100 may obtain the chassis logs from a log file 106. A copy of the events from architecture 104 or log file 106 may be stored in log file 109.

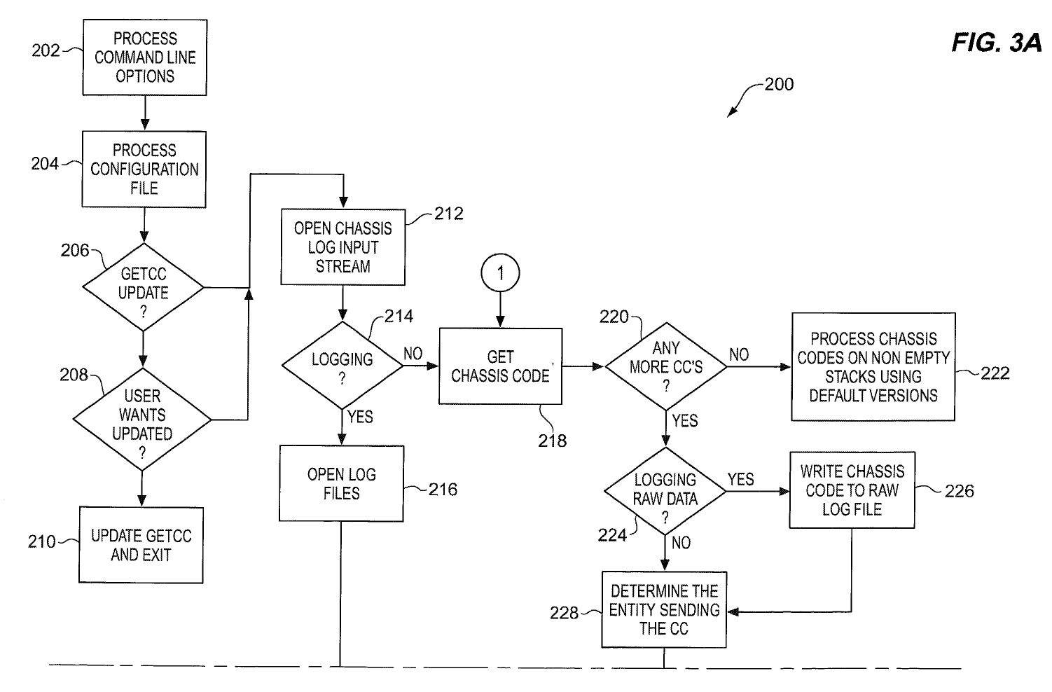

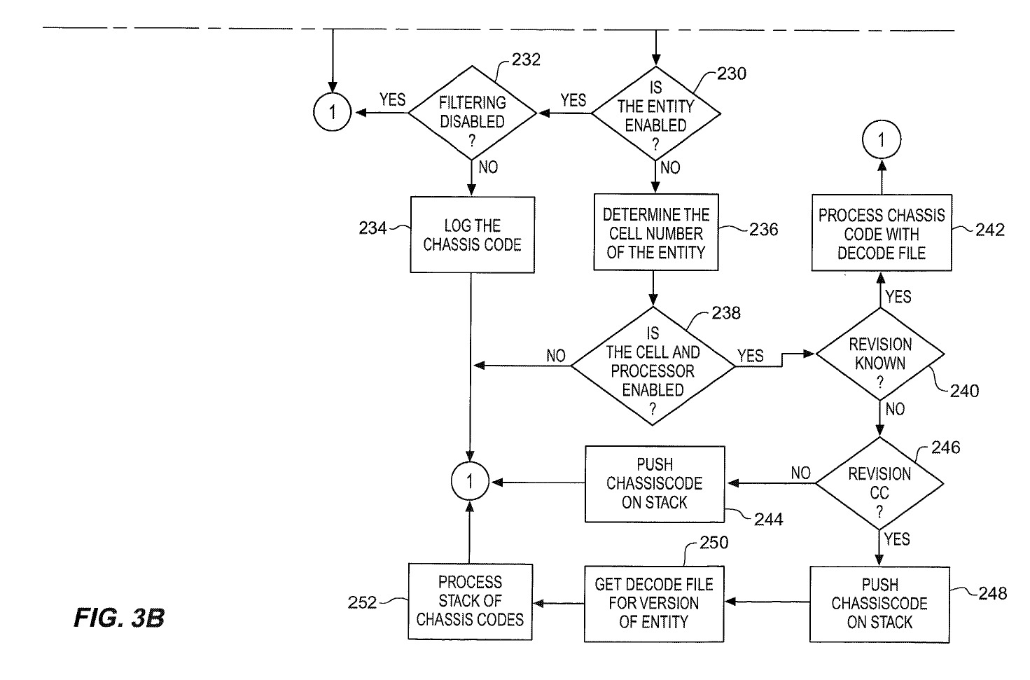

Getcc processing section 102 may be configured by various command line options 108 to control the processing of events (e.g., chassis logs) from architecture 104. Section 102 also preferably uses a configuration file 110 to determine options that the user would like to type in the command line. FIG. 3A and FIG. 3B show a flow chart 200 illustrating operational steps by getcc processing section 102. Processing by getcc section 102 begins (step 202) by parsing the command line to determine the user-selected command line options. Representative and non-limiting command line options for getcc processing section 102 are shown in Table 1. Processing by getcc section 102 continues with processing of the configuration file (step 204).

TABLE 1
Representative Command Line Options,
Parameters and Accompanying Description for Getcc

| Option | Parameters | Description |
|---|---|---|
| -l | Filename | Log file of chassis codes. The file is |
| -log, -logfile) | | created, overwritten, or appended |
| | | depending on other parameters. |
| -config | Filename | Specifies the path and filename of the |
| (-configuration) | | configuration file. If not specified, a |
| | | default name (e.g., getccConfig.rc) may |
| | | be referenced. |
| -c (-cell) | Cell Number | Specifies the chassis codes from the |
| | | architecture cell to be processed. This |
| | | option may be used more than once in the |
| | | command line. If omitted, then all cell |
| | | chassis codes are processed. |
| -proc | Processor | Specifies that chassis codes from the |
| | Number | processor number on each specified cell |
| | | are to be processed. This option may be |
| | | used multiple times to allow the selection |
| | | of chassis codes from more than one |
| | | processor. |
| -decodecc | N/A | Separates the chassis code into parts. The |
| | | configuration file specifies the algorithm. |
| -p | N/A | Prints the chassis codes to standard output |
| | | file. If omitted then the output from the |
| | | analyzer is the only output written to |
| | | standard output (subject to other options |
| | | changing what is written to standard |
| | | output). |
| -default | [[Entity:] | Causes the version chassis to be ignored |
| | Version] | and the specified default string to be used |
| | | as the version for the specified entity. |
| | | The version is used to determine the file |
| | | associated with converting chassis codes |
| | | to text strings. |
| -a | N/A | Specifies that output files are to be opened |
| (-append) | | in append mode. |
| -raw | <Filename> | Specifies that chassis codes are to be |
| | | written to the specified file before |
| | | filtering. |
| -i | <Filename> | Specifies that the specified file is used to |
| (-f, -file) | | access the chassis codes. |
| -makeconfig | [Filename] | Specifies that a default configuration file |
| | | is to be created with the specified |
| | | filename. If the filename is omitted, a |
| | | default file (e.g., getccConfig.rc) is |
| | | created (or overwritten if the file exists) |
| -x | N/A | Writes all filtered out chassis codes to |
| | | standard output. By default, all filtered |
| | | out chassis codes are not converted to a |
| | | text string. |
| -v (-version) | N/A | Prints the version of the program to |
| | | standard output and exits the program. |
| -nonet | N/A | Specifies disabling of the auto update |
| | | features. |
| -h (-help) | N/A | Lists all of command line options to |
| | | standard output and exits the program. |

The configuration file of Table 1 may be used to specify command line options and other information or actions that are not easily input in the command line. If a configuration file is not specified, a default file (e.g., getccConfig.rc) is assumed as the configuration input file. Typically, the configuration file specifies a location of the architecture for updates, a telnet port to access chassis logs, and options for each entity, such as revision chassis log, chassis log file, decode file, and chassis log masks. Table 2 below lists preferred and non-limiting features of the configuration file:

TABLE 2
Representative Configuration File Features for Getcc

| Command | Parameters | Description |
|---|---|---|
| server | <IP Address\| | Specifies the ftp server (e.g., architecture |
| | machine internet | 104) to be accessed by getcc to look for |
| | name> | updates, decode files, and analysis files. |
| location | <directory> | Specifies the directory containing the |
| | | getcc files on the server. |
| ccport | port number | To access a machine, getcc telnets to the |
| | | machine using the specified port number. |
| revcc | <entity> | Chassis code that specifies the revision of |
| | <chassis code> | an entity. |
| revmask | <entitiy> | Specifies a mask that is applied to a |
| | <chassis code | chassis code to detect if a revcc is |
| | mask> | detected. |
| decodefile | <entity> | Specifies the decode file that contains the |
| | <filename> | conversion of chassis code number to text |
| | | string. |
| script | <entity> | Specifies the analysis tool used by an |
| | <filename> | entity to detect problems with the system. |
| | | All chassis codes for the specified entity |
| | | are passed to the program as detected. The |
| | | program (filename) is downloaded from |
| | | the server to the local working directory if |
| | | not available. |
| machine | <IP address or | Specifies the machine to be accessed using |
| | machine name> | telnet to collect chassis codes. |
| ccmask | <entity> | Specifies a mask (XOR) that is applied to |
| | <mask> | each chassis code from the specified entity |
| | | prior to processing chassis code. |
| default | <entity> | As an entity changes versions, the chassis |
| | <version number> | codes also change. Normally, a chassis |
| | | code is output by the entity to specify |
| | | the version. The version is used to |
| | | determine what file is used to convert |
| | | the chassis codes to text strings. This |
| | | option overrides the real-time version from |
| | | the entity with the specified version, |
| | | avoiding buffering of chassis codes from |
| | | an entity until the version chassis codes |
| | | are detected. |
| physical | <data> | Chassis codes also output data. The |
| location | <text string> | chassis codes may specify the type of |
| | | data. One type is called a physical |
| | | location. This type specifies that the |
| | | data identifies a replaceable element |
| | | within the machine. This option specifies |
| | | a valid physical location and the |
| | | identifying text string. |

After getcc section 102 processes the command line and configuration files (steps 202, 204), getcc section 102 checks architecture 104 (as specified in the configuration file) for any updates to itself (step 206). If there is an update, the user is prompted (step 208) whether getcc section 102 should be updated to the latest revision. Revisions may be saved, and updated software for getcc section 102 may be re-executed as a matter of design choice (step 210).

Once configured, the input stream of chassis codes from architecture 104 (or log file 106) is opened (step 212). By way of example, the input stream may be from (a) a file 106 that was used to store chassis codes, or (b) a telnet session to architecture 104. If a telnet session is used, getcc section 102 may prompt the user for a password to access architecture 104.

If a user of system 100 has requested a log of chassis codes (step 214), then one or more log files 109 are opened (step 216). There may be more than one type of log file 109. A first type is a raw chassis code log file; getcc section 102 takes the chassis codes as received from architecture 104 and writes them to log file 109 without processing. Such an output generally consists of one chassis code per line with the raw ASCII hexadecimal data. A second log file type is processed chassis code data that contains filtered chassis codes, the raw hexadecimal data, entity name, and text string conversions. According to a typical operation, a user logs the raw data to preserve the ordering of chassis logs from the system, and getcc section 102 thereafter processes the data to create a second log file type, as needed.

Similar to an “end of file” detect operation, chassis codes may be read (step 218) from the input stream one at a time until the input stream no longer contains chassis codes (step 220). If there are no chassis codes, default versions of the chassis codes may be used (step 222). If there is a chassis code, the following processing ensues:

1) If raw logging is enabled (step 224), the chassis code is written to log file 109 (step 226) to preserve the raw data and ordering of chassis codes read from the input stream.

2) The entity of the chassis code is extracted from the chassis code (step 228).

3) A check is made to see if the user has requested that the entity specified by the chassis code is to be processed (step 230). This may for example be accomplished in the configuration file by specifying a decode file for the entity. If the entity is disabled, then a check is made (step 232) to see if the user has requested to print all chassis codes to the log file from the command line. If so, then the chassis code is logged (step 234). Otherwise, the chassis code is discarded and the next chassis code is read from the input stream.

If the entity specified by the chassis code is to be processed (step 230), then the cell number is extracted from the chassis code (step 236) if the entity exists on a cell. If the cell (or processor on the cell) is not enabled (via the command line, step 238), the chassis code is discarded and the next chassis code is read from the input stream. Otherwise, if a chassis code was already received from the entity that specified the revision (step 240), the chassis code is processed (step 242) and the next chassis code is read from the input stream.

If the revision for the entity is not known (step 240), the chassis code is evaluated for its revision chassis code (step 244). If it is not revision chassis code, the chassis code is buffered (step 246) and getcc section 102 waits for the revision chassis code. If, however, it is the revision chassis code, the revision chassis code is buffered (step 248), and the decode file is retrieved from the architecture (if the decode file is not available, step 250); each chassis code is then processed and buffered for the specified entity (step 252).

Chassis codes may take the form of two 64-bit numbers (one number detailing system information, one number defining context sensitive information). In accord with preferred embodiments, the processing of chassis codes (step 252) preferably include the following steps:

1) Mask the raw chassis code with the ccmask value.

2) Convert the chassis code to a hex string.

3) Log the chassis code if filtered logging is enabled.

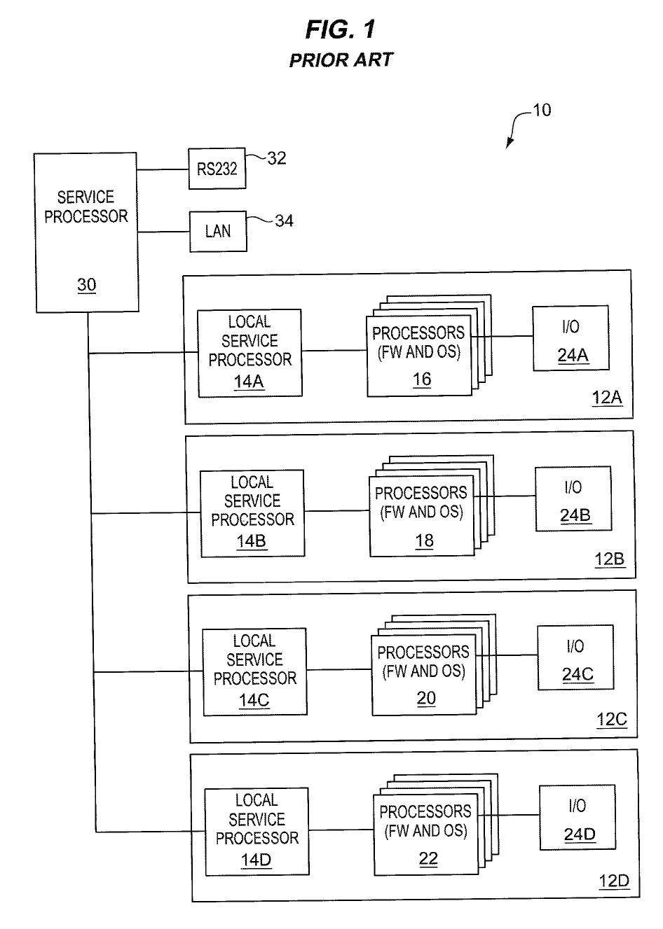

4) Send the chassis code and the text string to the analyzer associated with the entity. FIG. 2 shows several analyzers 120 for various entities within architecture 104. By way of example, analyzer 120A analyzes text strings from getcc section 102 and associated with a firmware entity (e.g., a processor 20, FIG. 1) within architecture 104; analyzer 120B analyzes text strings from getcc section 102 and associated with I/O driver entities (e.g., I/O drivers 24, FIG. 1) within architecture 104; analyzer 120C analyzes text strings from getcc section 102 and associated with a service processor entity (e.g., service processor 30, FIG. 1) within architecture 104; analyzer 120D analyzes text strings from getcc section 102 and associated with a power monitor of architecture 104; analyzer 120E analyzes text strings from getcc section 102 and associated with a cabinet monitor of architecture 104; and analyzer 120F analyzes text strings from getcc section 102 and associated with local server processor entities (e.g., processors 14, FIG. 1) within architecture 104.

5) If “decodecc” (Table 1) is specified on the command line, split the chassis code into the various parts and print it to standard output.

In accord with preferred embodiments, if there are no more chassis codes, the following steps occur:

1) If an entity has not outputted a chassis code that specifies the version of the entity, then the conversion of that chassis code to text does not occur. While waiting for the version chassis code, all chassis codes for that entity are buffered. If the end of chassis codes is detected before a version chassis code is found, the default version for the entity is used to specify the conversion file.

2) Since the close of the input stream implies that there are no more chassis codes, each entity is checked to see if any buffered chassis codes exists. If so, the default version for that entity is assumed and each chassis code is process as previously described by converting the chassis code to a text string, passing the chassis code to the entity's analyzer, and logging specified data.

With further regard to FIG. 1, a graphical user interface may connect with connections 122 to facilitate and control and input to system 100. Connection 122A may for example connect to getcc section 102; connection 122B may for example connect with each analyzer 120. Connection 122A may for example facilitate access to email destinations to which system 100 may communicate problems isolated by getcc section 102 and any analyzer 120.

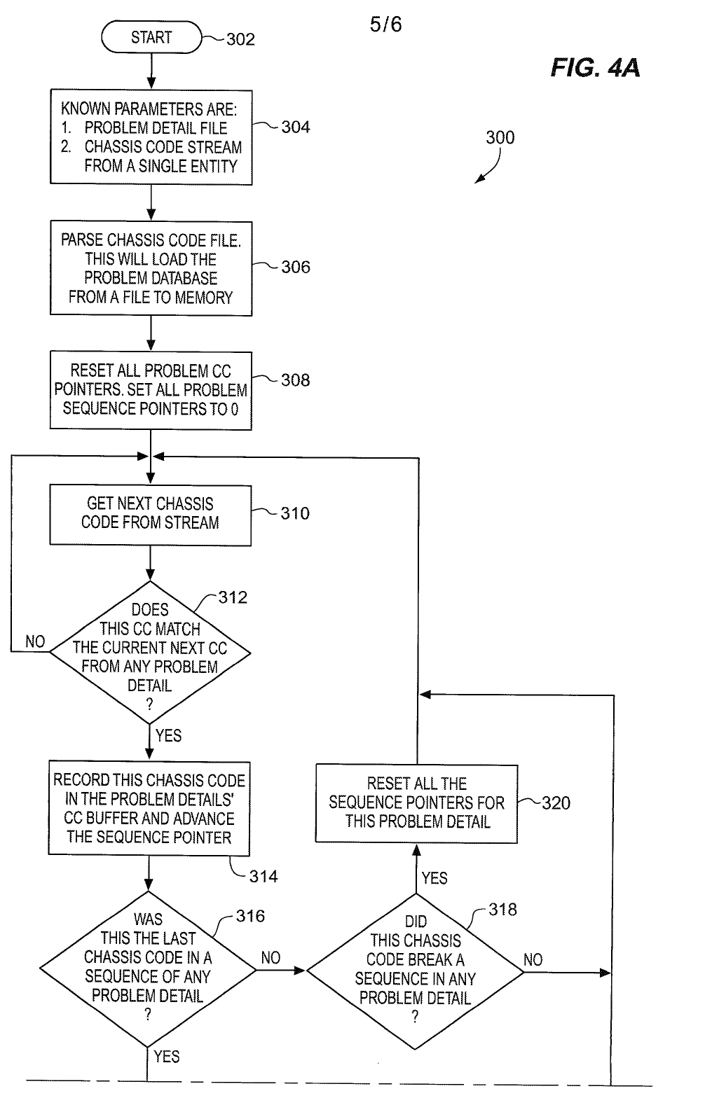

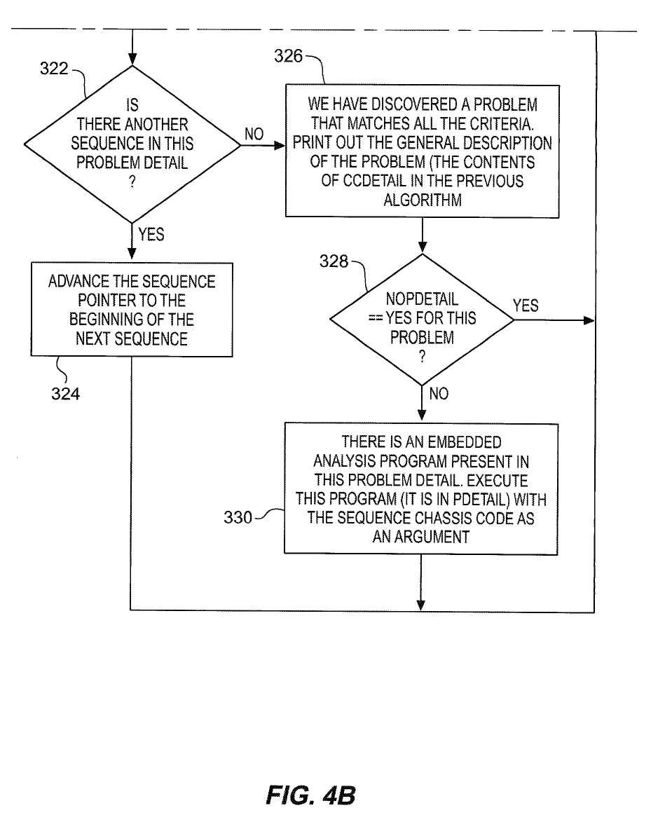

FIG. 4A and FIG. 4B show a flow chart 300 illustrating non-limiting operational steps by an analyzer 120 of FIG. 2. Below-listed pseudo-code further assists in understanding operations of FIG. 2, FIG. 4A and FIG. 4B. Flow chart 300 starts at step 302. The parameters input to the analyzer (step 304) include a problem detail file associated with a chassis code for the associated entity. The chassis code file is parsed (step 306) to load the problem database from a file to memory. All problem chassis code pointers are then reset (step 308); all problem sequence pointers are set to 0 (step 308). The next chassis code is then retrieved (step 310); and that code is compared to the current next chassis code from any problem detail (step 312). If a match occurs, this chassis code is stored in the problem detail buffer and the sequence pointer is advanced (step 314); if no match occurs, the next chassis code advances (step 310).

The analyzer then determines whether the chassis code was the last code in a sequence of any problem detail (step 316). If not, the analyzer determines whether the chassis code breaks a sequence in any problem detail (step 318). If yes, the sequence pointers are reset (step 320) for the particular problem detail. If not, the problem detail is scanned for additional sequences (step 322). If another sequence exists in the problem file, the sequence pointer advances to the beginning of the next sequence (step 324). If another sequence does not exist, a problem exists that matches the criteria and a written summary is prepared describing the problem (step 326). The problem detail is then scanned for particular information about the problem (step 328). If no detail exists, an embedded program may exist for execution; the embedded program is executed with the chassis code as the argument (step 330).

Pseudo-code illustrating extraction of problem detail, including execution of the embedded program, may be illustrated in the following manner (and so long as there are lines in the problem file):

1: ProblemDetail :=1

2: Parse File to token <<PROBLEM xxxx>>

3: Set name of problem ProblemDetail to xxxx

4: SequenceID :=1

5: Parse File to token <<SEQUENCE>>

6: CCID :=1

7: CC[SequenceID][CCID]:=next entire line of file

8: If <next line of file>==<<SEQUENCE>>then SequenceID :=SequenceID+1; go to 6

9: If <next line of file>==<<DETAIL>>then go to 12

10: CCID :=CCID +1

11: goto 7

12: CCDETAIL ==CCDETAIL +<next line of file>

13: If <next line of file>==<<END>>then NOPDETAIL :=YES, ProblemDetail :=ProblemDetail +1; go to 2

14: If <next line of file>!=<<PDETAIL>>then go to 12

15: NOPDETAIL :=NO

16: PDETAIL :=PDETAIL +<next line of file>

17: If <next line of file>==<<END>>ProblemDetail :=ProblemDetail +1; go to 2

18: Go to 16

With regard to the above-listed pseudo code, “CC” denotes chassis code; “CCDETAIL” denotes text detail desired for display to a user of system 100; and “PDETAIL” denotes a program (e.g., executable file) adapted to perform in-depth analysis of problem detail and chassis codes. The ProblemDetail syntax includes items like <<PROBLEM xxxx>>, <<SEQUENCE>>, <<DETAIL>>, <<PDETAIL>>and <<END>>. <<PROBLEM xxxx>>, denotes the problem identifier string. <<SEQUENCE>>denotes one or more sequence statements, for example textual strings representing sequential or “back to back” chassis codes. <<DETAIL>>denotes text describing the general problem. <<PDETAIL>>denotes subroutine (e.g., a PERL subroutine) that decodes the data field to provide a more sophisticated analysis of the problem. <<END>>ends the problem detail.

The invention provides certain advantages over the prior art. First, the getcc functions provide automatic detection of known problems. Second, in that getcc preferably operates through software routines, the extraction tool system is upgradeable. Third, detected problems may be detailed for review by relatively un-trained persons. Fourth, log files may be reviewed remotely or communicated to remote machines.

The invention thus attains the objects set forth above, among those apparent from the preceding description. Since certain changes may be made in the above methods and systems without departing from the scope of the invention, it is intended that all matter contained in the above description or shown in the accompanying drawing be interpreted as illustrative and not in a limiting sense. It is also to be understood that the following claims are to cover all generic and specific features of the invention described herein, and all statements of the scope of the invention which, as a matter of language, might be said to fall there between.

What is claimed is:

1. A method for analyzing text strings associated with events from electronic architecture, the architecture of the type having one or more entities generating the events, comprising the steps of:
processing the text strings; and
transforming the text strings to human interpretable statements summarizing at least one of the events associated with the text strings.

2. A method of claim 1, wherein the step of transforming the text strings comprises transforming the text strings to an English statement setting forth one or more of problems and system health of the architecture.

3. A method of claim 1, wherein the step of processing the text strings comprises processing the text strings according one of the entities associated with the text string.

4. A method of claim 2, wherein the step of processing the text strings comprises processing text strings representative of one or more chassis code of the one entity.

5. A method of claim 4, wherein the step of processing the text strings representative of one or more chassis codes comprises the steps of parsing the chassis codes and sequentially processing each of the chassis codes.

6. A method of claim 4, wherein the step of processing the text strings comprises processing problem detail of the chassis codes.

7. A method of claim 6, further comprising executing an embedded program with one of the chassis codes as an argument, to further analyze problems associated with the one entity.

8. A method of claim 1, further comprising printing the statement.

9. A method of claim 1, further comprising automatically emailing at least part of the statement to an email destination.

10. A method of claim 1, further comprising the step of acquiring the text strings from an extraction tool coupled to the architecture.

11. A method of claim 1, the extraction tool extracting the events from the architecture, separating the events according to the entities, and transforming the events to one or more text strings.

12. A method of claim 11, further comprising accessing one or more analyzers coupled to the extraction tool.

13. A method of claim 12, wherein the step of a accessing comprises utilizing a graphical user interface coupled to one or more of the analyzers.

14. A method of claim 12, wherein each of the analyzers processes text strings associated with one of the entities.

15. A system for analyzing text strings associated with events from electronic architecture, the architecture of the type having one or more entities generating the events, comprising:
one or more analyzers for analyzing the text strings and for producing a human interpretable statement about one or more of the events, each of the analyzers associated with one of the entities; and
an interface for coupling the analyzers to an extraction tool acquiring the events from the architecture.

16. A system of claim 15, wherein the entities comprise one or more of firmware, software, processors, architecture monitors, power monitors, cabinet monitors, and I/O drivers, and wherein the events comprise chassis logs from one or more of the firmware, software, processors, architecture monitors, power monitors, cabinet monitors, and I/O drivers.

17. A system of claim 15, further comprising an extraction tool coupled to the interface, the extraction tool extracting the events from the architecture, separating the events according to the entities, and transforming the events to one or more of the text strings.

18. A system of claim 15, wherein the text strings comprise problem detail and chassis code.

19. A system of claim 18, wherein the problem detail comprises an embedded program executable to perform further analysis of the text strings.

20. A system of claim 15, the interface publishing the statement in one or more of computer memory, paper form, and email.
